(19) United States
(12) Patent Application Publication
(10) Pub. No.: US 2023/0100840 A1
(43) Pub. Date: Mar. 30, 2023

(54) SYSTEMS AND METHODS FOR COMPACT VISUAL SENSING AND MOTION ESTIMATION

(71) Applicant: Intellishot Holdings Inc., Boca Raton, FL (US)

(72) Inventor: Michael Janusz WOODS, Mountan View, CA (US)

(21) Appl. No.: 17/955,494

(22) Filed: Sep. 28, 2022

Related U.S. Application Data
(60) Provisional application No. 63/360,387, filed on Sep. 28, 2021.

(51) Int. Cl. G01C 21/16; G01C 25/00

(52) U.S. Cl. CPC G01C 21/1656; G01C 25/005

(57) ABSTRACT

Various embodiments are directed to improvements in the design of optical and/or motion sensors and the architecture and implementation of systems that contain such sensors to enable the physical size of such sensors and systems to be dramatically reduced and to enable the implementation of such systems to be dramatically simplified. This has applications in the design and manufacture of electronic devices containing such sensors, with direct impacts to many market segments, including, without limitation, augmented reality, virtual reality, autonomous vehicles, security, and the like.

### CROSS REFERENCE TO RELATED APPLICATIONS

This application claims benefit of U.S. Provisional application No. 63/360,387, filed Sep. 28, 2021, the contents of which are incorporated herein by reference in their entirety.

### FIELD OF THE INVENTION

This set of inventions relates generally to the fields of visual and motion sensing, and more specifically to new and useful improvements in the design of optical and/or motion sensors and the architecture and implementation of systems that contain such sensors to enable the physical size of such sensors and systems to be dramatically reduced and to enable the implementation of such systems to be dramatically simplified. This has applications in the design and manufacture of electronic devices containing such sensors, with direct impacts to many market segments, including, without limitation, augmented reality, virtual reality, autonomous vehicles, security, etc.

### BACKGROUND

In current practice, many electronic devices are manufactured to contain visual and/or motion sensors.

The visual sensors are typically some form of discrete camera component, meaning a combination of optical elements (lenses and/or mirrors) and a sensor, such that the action of the optical elements is to modify the direction and/or divergence of photon wavefronts (light) entering the device, so that when those wavefronts arrive at the sensor, they are in an appropriate position and level of focus to produce a clear image on the sensor. Referring to FIG. 1, refraction of radiation (incoming from a first direction 2, then focused 3 using a lens 6; incoming from a second direction 4, then focused 5), such as light, is shown through a lens (6) onto a sensor (8). This combination of optical elements and sensor may be a separate device, or a sub-component of another device, such as an optical depth sensor, and may include other elements as well, such as selective wavelength filters, active illuminators, mechanical or electronic shutters, etc. These components typically provide direct image data, meant to represent the actual physical view of the world and properties thereof in a way that matches closely with human perception.

Motion sensors known as “MEMS” (or “Microelectromechanical Systems”) units, components, or devices may be utilized in various system configurations. For example, some motion and/or acceleration sensors may be known as “IMUs” (or “Inertial Measurement Units”) and configured to assist in the measurement and/or determination of accelerations and/or positions. These sensors typically are discrete components (FIG. 2 illustrates a single chip MEMS IMU, 10, depicted in a typical chip packaging configuration) which contain within them miniaturized sensors capable of measuring dynamic variables of whatever they are attached to. In particular, they commonly include measurements for X/Y/Z components of linear acceleration, as well as angular velocity in the XY/YZ/ZX planes. Sometimes these components also include sensors to measure X/Y/Z components of DC (low frequency) magnetic fields.

These components, when used together on a motion-sensitive device (such as a VR headset) often require extensive supporting architecture, including, but not limited to, data lines, power lines, mechanical vibration dampers, sizable transparent apertures in the outer shell of the device, and significant onboard compute power.

These components, when used together on a motion-sensitive device also often require extensive calibration procedures to improve the accuracy and relevance of their outputs. These calibration procedures typically include intrinsic calibrations designed to improve the accuracy of the direct data outputs of these components, as well as extrinsic calibrations designed to identify the relative position and orientation offsets between the sensors and each other, or other components in the system (e.g., displays, etc), so that their outputs may be properly aligned and analyzed together.

Since it is advantageous to produce smaller and lighter devices with the simplest calibration and system architecture requirements, it is clear that the intelligent miniaturization and combination of visual and/or motion sensors is of high importance. This provisional patent application discusses methods for the above, as well as systems and methods for otherwise reducing calibration and/or system requirements of such integrated devices.

### BRIEF DESCRIPTION OF THE DRAWINGS

FIG. 1 illustrates an optical configuration with a refractive lens.

FIG. 2 illustrates a chip configuration.

FIG. 3 illustrates a sensor configuration encountering radiation, such as light.

FIG. 4 illustrates a sensor integration featuring an aperture.

FIG. 5 illustrates a system integration configuration featuring an aperture.

FIGS. 6A-6D illustrate various configurations comprising sensors in accordance with the present invention.

FIG. 7 illustrates various aspects of a calibration configuration.

FIG. 8 illustrates various aspects of a dynamic manufacturing configuration.

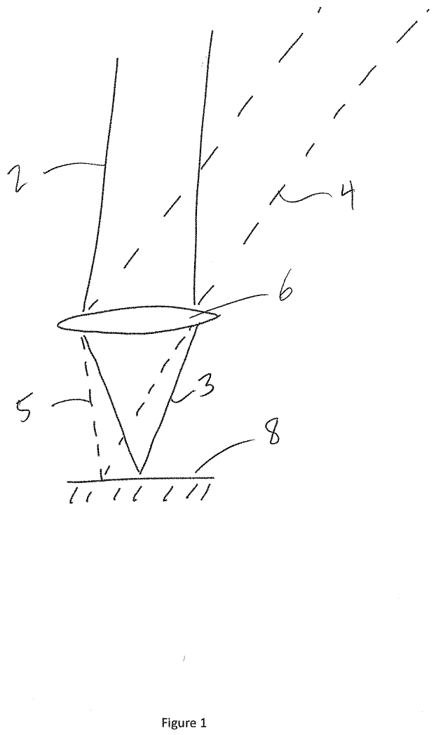

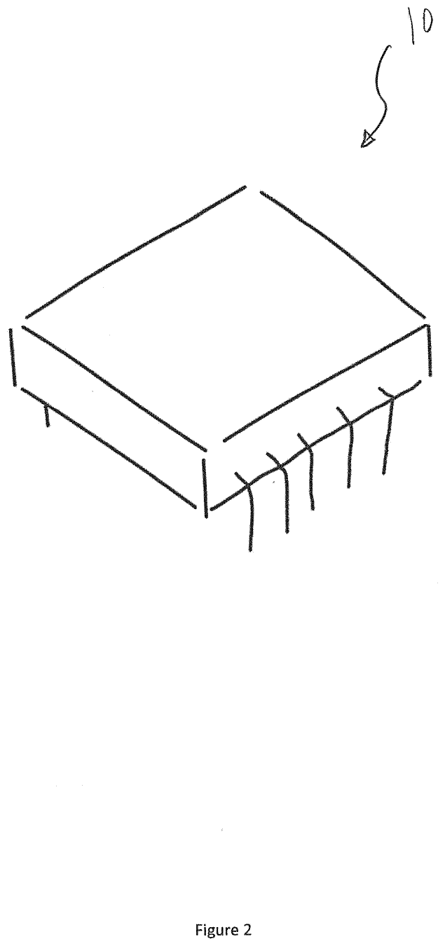

### SUMMARY

Various embodiments are directed to improvements in the design of optical and/or motion sensors and the architecture and implementation of systems that contain such sensors to enable the physical size of such sensors and systems to be dramatically reduced and to enable the implementation of such systems to be dramatically simplified. This has applications in the design and manufacture of electronic devices containing such sensors, with direct impacts to many market segments, including, without limitation, augmented reality, virtual reality, autonomous vehicles, security, and the like.

### DETAILED DESCRIPTION

This application claims priority to U.S. Provisional Patent Application Ser. No. 63/360,387 and filed on Sep. 28, 2021, which is incorporated by reference herein in its entirety.

The following description of the preferred embodiments of the invention is not intended to limit the invention to these preferred embodiments, but rather to enable any person skilled in the art to make and use this invention. All specific descriptions herewith should be considered particular, non-limiting, examples of the general principles invented, described, and claimed here.

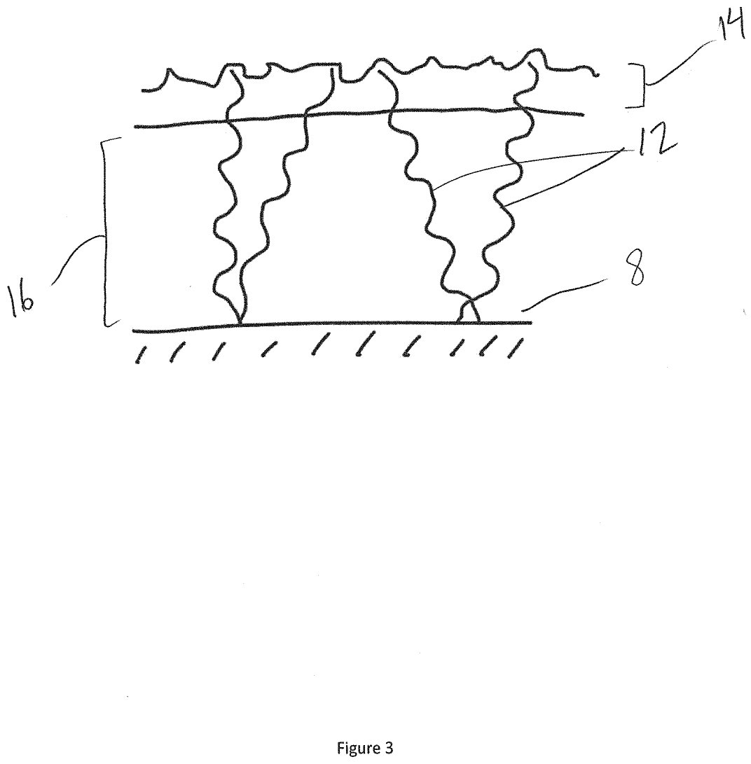

In particular, in the description herein, many preferred embodiments will refer to visual sensors in the form of “diffractive optics visual sensor(s)” (or “DOVS”). Such sensors typically may comprise elements such as a diffractive element, typically either in the form of an amplitude or phase grating, and a sensing element (such as a CCD or CMOS sensor), such that wavefronts incident on the entry surface of the diffractive element undergo a combination of constructive and destructive interference by the time they arrive at the sensing element. For example, referring to FIG. 3, constructive and destructive interference on a sensor (8) after radiation (12), such as light, passes through optical components 14, 16, such as a diffractive element). This is done in such a manner that the sensed amplitudes at the sensing element contain as much of the information present in the original wavefronts as possible, though the information typically ends up encoded in some manner that may require significant calculation to retrieve an image corresponding to human perception.

The advantage of such DOVS devices is that they can be made much smaller than typical refractive optics visual sensors because they do not require the extensive physical size and spacing of refractive elements such as lenses and mirrors.

However, while the preferred embodiments described below will reference DOVS devices, in general, they may also be achieved with traditional refractive optics devices, and so all following descriptions should be considered to encompass refractive optics devices as well.

Further, the preferred embodiments discussed below will reference “visual” sensors, meaning sensors designed to be sensitive to light amplitudes, wavelengths, and properties in a similar range to the sensitivity of the human eye. All of the preferred embodiments, however, may be implemented with other forms of electromagnetic sensors, sensitive to amplitudes, wavelengths, and properties of electromagnetic waves outside the sensitivity of the human eye. These may include, without limitation, infrared sensors, ultraviolet sensors, polarization sensors, microwave sensors, x-ray sensors, etc.

Various embodiments may comprise system and method for producing a miniaturized component capable of producing relative pose information as a direct output from a combination of integrated visual and motion sensors.

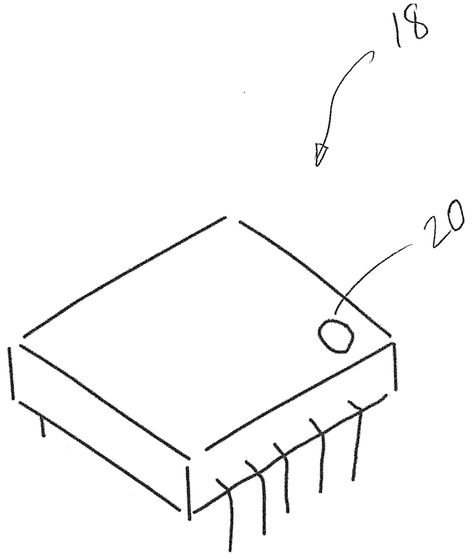

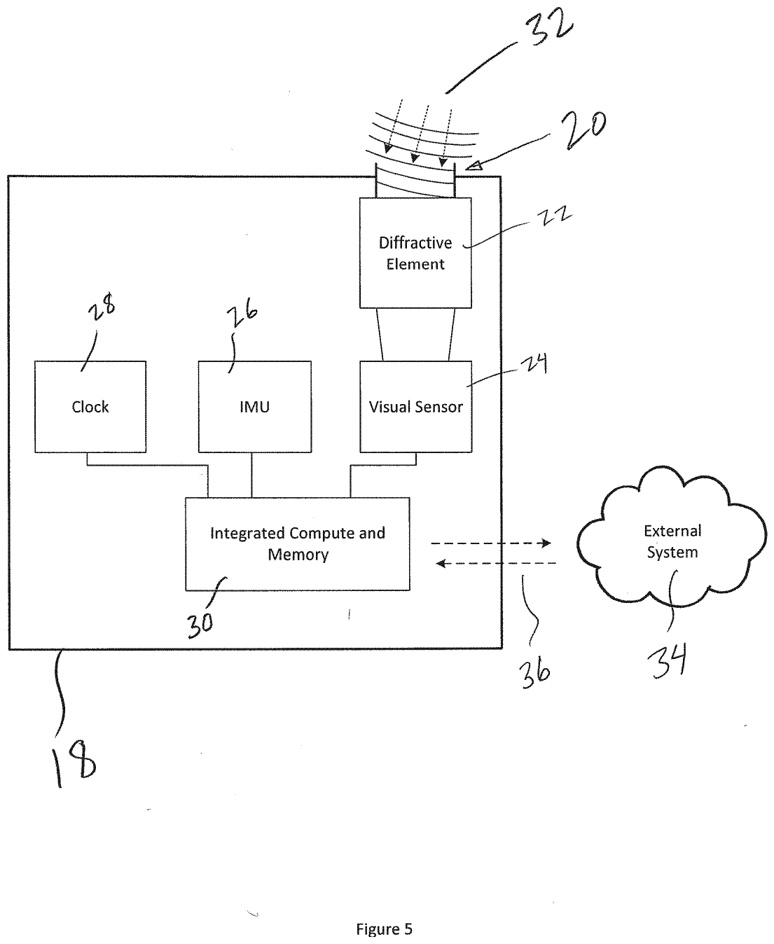

In typical use, visual sensors and IMUs are separate components. However, to aid miniaturization, they may be combined, either as multiple devices within a single component package, or as multiple integrated devices on a single piece of substrate within a single component package. This single component package may also include an onboard resonator clock, or may include an external input for receiving a clock signal from another system. In the case of DOVS, the diffractive element may also be included directly on top of the sensor substrate, either as an active part of the component packaging, or as a sub-part within the component packaging, paired with an aperture in the component packaging to allow light to be incident on the diffractive element (FIG. 4 illustrates a single component visual+motion sensor assembly 18 with an aperture 20 in the component packaging). This single component package (18) may also include onboard computation and memory capacity, either in the form of general purpose processing devices, or in the form of purpose-designed hardware. This computation and memory capacity may be designed to run algorithms developed in controlled test scenarios such as deep neural networks trained with extensive data sets. This computation and memory capacity may also be paired with an input mechanism so that its onboard algorithms may be updated by an external system. The algorithms running on this onboard computation and memory capacity may be designed to operate on the collection of raw data from the DOVS, the integrated IMU, and the clock signal (as well as any other input data available) in order to produce a direct estimate of relative pose (linear translation and angular rotation, both in, e.g., three dimensions) between different timesteps. These timesteps may be synchronized with the clock signal (if present), or may be produced “on demand” as a response to some input signal. FIG. 5 illustrates a block diagram of single-component combined visual+motion sensor (18) utilizing an internal clock (28) and integrated compute and memory (30), and communicating (36) with an external system (34); an IMU (26) component also is shown, along with a visual sensor (24) configured to receive inputs from a diffractive element (22) which may be exposed to incoming radiation (32), such as light, through the aperture (20). These relative pose estimates may be relative to the previous pose estimate, relative to some “original” pose, or dynamically, relative to the pose at any particular time, possibly as selected by an external input signal.

Such a device may also include onboard algorithms to analyze the data from the DOVS and IMU components, and/or any other external data in order to produce calibration coefficients relating either to the intrinsic operation of the individual sensing components, or to the extrinsic relationship between them. Such algorithms may be implemented with the techniques of kalman filters, deep neural networks, or other techniques. Such calibration coefficients may be partially or wholly bootstrapped via initial estimations and measurements taken during the manufacturing process of the component. In particular, some of the calibration coefficients, such as the extrinsic translation offsets between components, may be taken directly from the high-accuracy and high-precision semiconductor manufacturing masks used in the manufacturing process.

Various embodiments may comprise a system and method for integrating multiple miniaturized visual sensors into an electronic device while offloading the associated compute.

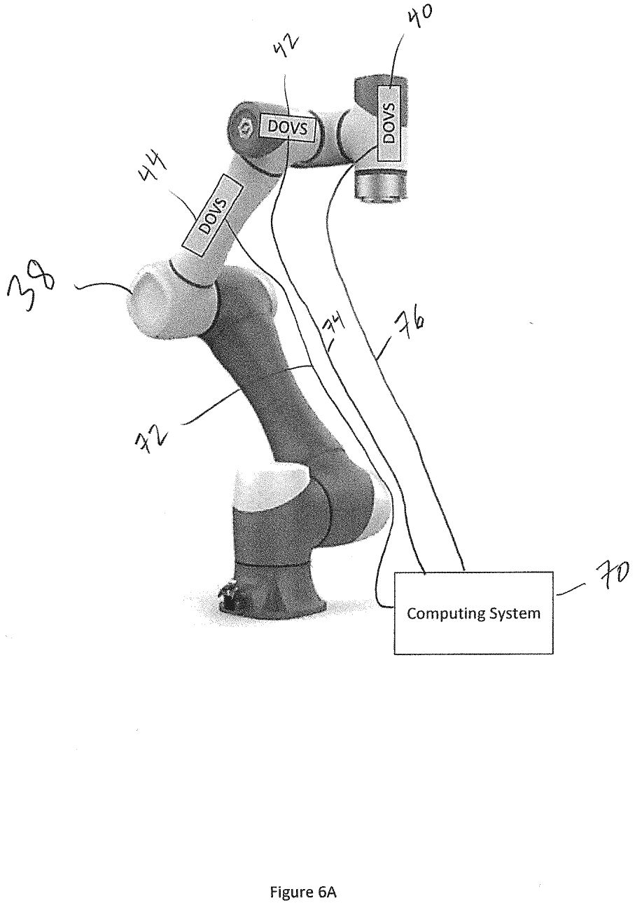

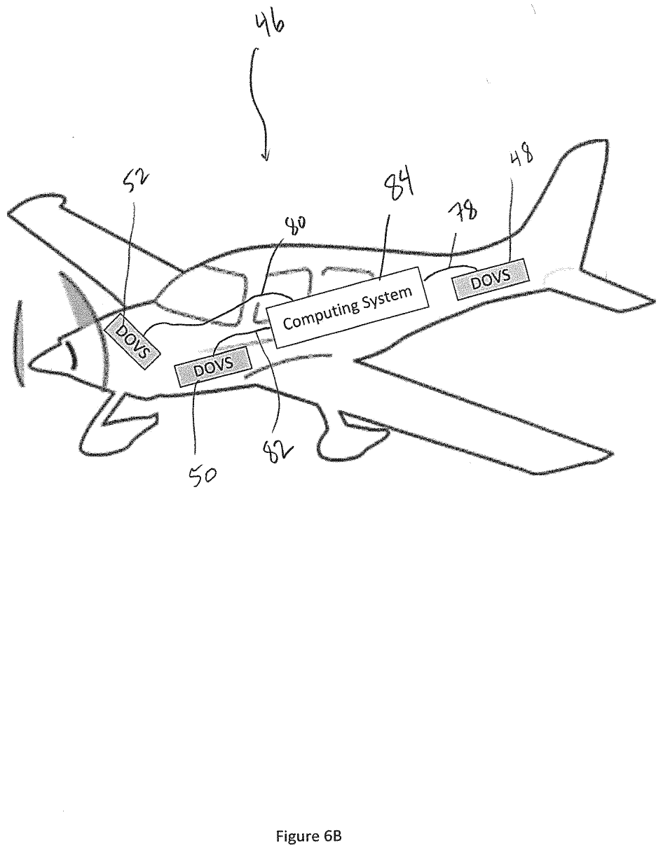

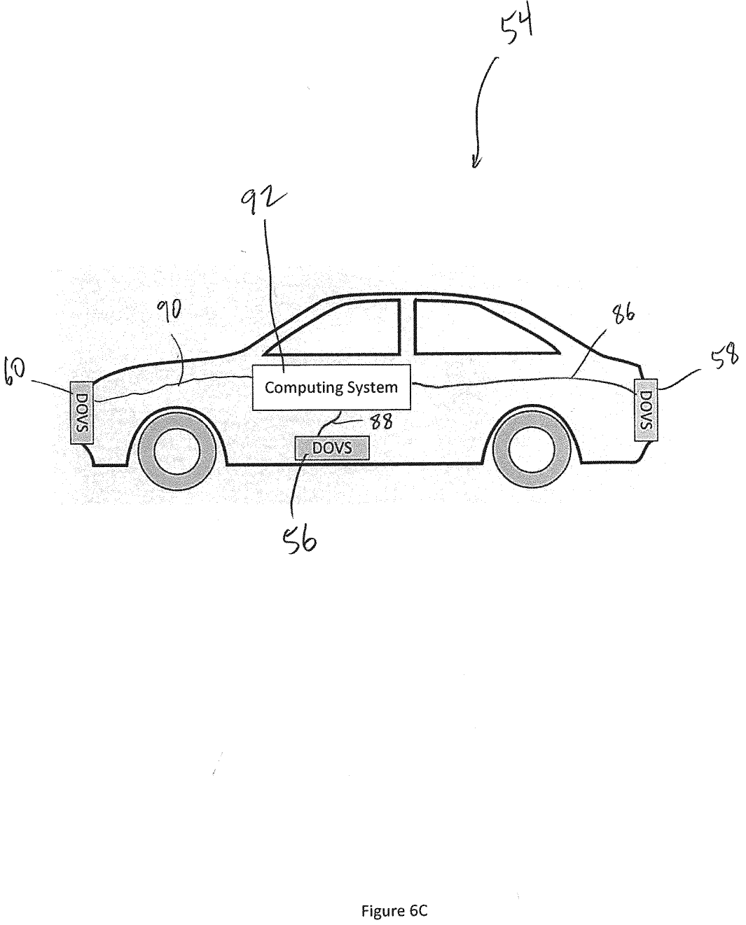

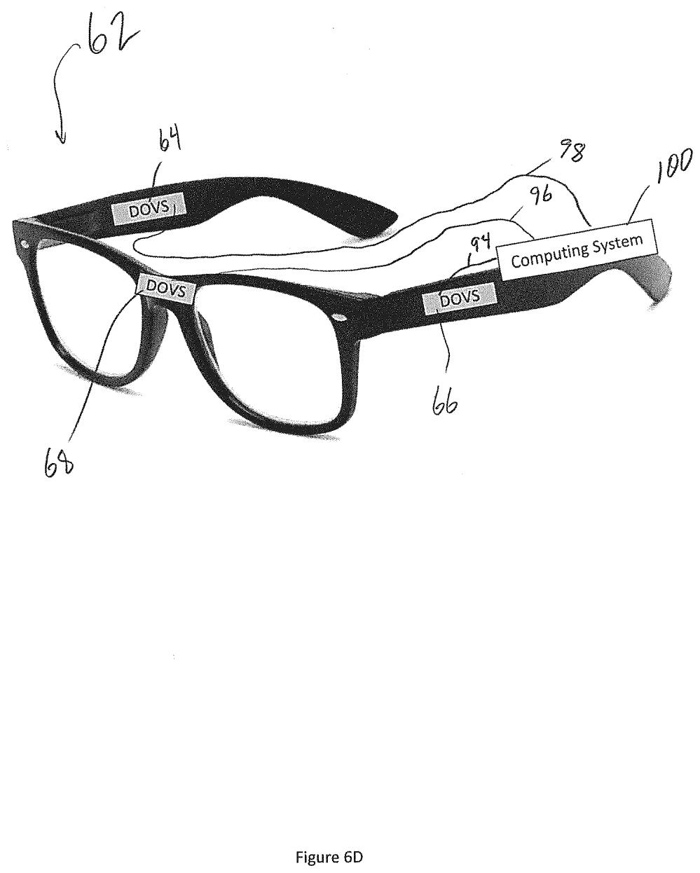

Multiple DOVS devices may be integrated as components into single electronic devices. FIGS. 6A-6D illustrate configurations with multiple DOVS units integrated to function with an operatively coupled computing system to assist with various environmental sensing and detection challenges. FIG. 6A illustrates a robot arm (38) with a computing system (70) operatively coupled (such as via wired or wireless connectivity; 72, 74, 76) to three DOVS devices (40, 42, 44). FIG. 6B illustrates an aircraft (46) with a computing system (84) operatively coupled (such as via wired or wireless connectivity; 78, 80, 82) to three DOVS devices (48, 50, 52). FIG. 6C illustrates an road vehicle (54) with a computing system (92) operatively coupled (such as via wired or wireless connectivity; 86, 88, 90) to three DOVS devices (56, 58, 60). FIG. 6D illustrates an eyeglasses system (62) with a computing system (100) operatively coupled (such as via wired or wireless connectivity; 94, 96, 98) to three DOVS devices (64, 66, 68). Since such DOVS devices often require extensive computation before their outputs may be used, and since it is undesirable to constrain this computation to physically taking place on the same electronic device that integrates the DOVS components, the output of the DOVS components may be transmitted to the depicted computing systems, and/or an external device for processing. Such an external device may be either physically connected (e.g., with a wire) or connected wirelessly (e.g., using radio frequency links, etc). Such an external device may also be integrated with other communications infrastructure, and without limitation, such an external device may exist as an integrated component within cell towers, network switching hardware, a local area server, a remote server, or another electronic device such as a cell phone, tablet, or laptop computer. Each of these particular embodiments represents a different set of tradeoffs between important variables, such as latency, throughput, business models, accuracy, and cost.

Various embodiments may comprise a system and method for analyzing the output of multiple independent sensors and dynamically computing their relative positions and orientations (extrinsic calibration).

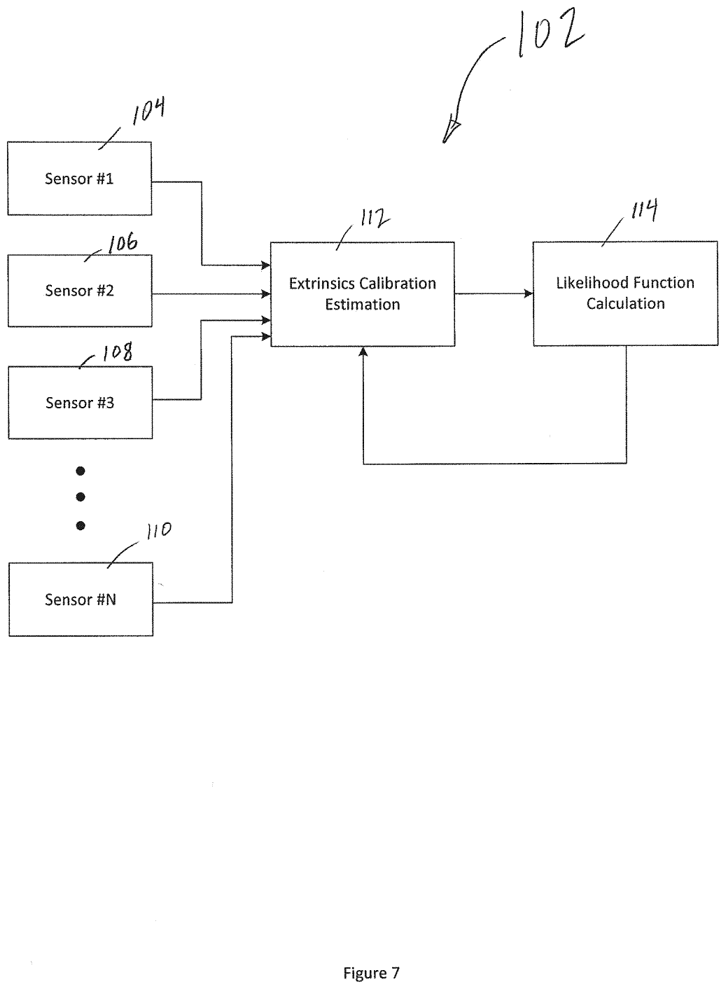

An electronic device may contain a multitude of sensors, such as the integrated “relative pose direct output” sensors described in #1 above. The outputs of these sensors may be treated as individual estimates of the relative pose of each sensor over time. These relative poses may be treated as inputs into an algorithm, such as one implemented using the methods of kalman filters, to produce a likelihood function, dynamically estimating the relative position and orientation of the multitude of sensors such as to maximize the computed likelihood of all of their results being simultaneously maximally correct. Referring to FIG. 7, block diagram for a system configuration (102) using input from multiple sensors (104, 106, 108, 110) to determine extrinsic calibration (112) parameters between those sensors with the aid of a likelihood function (114). These estimates of relative position and orientation may be bootstrapped with known data, e.g., from design and manufacturing tolerances. These estimates of relative position and orientation may also be subject to various constraints; e.g., two sensors, mounted to an especially rigid frame, may have a tighter constraint on their relative position and orientation, while two other sensors, separated by a hinge, may be allow a much looser degree of freedom corresponding to the known rotation ability of the hinge. The computation of such relative positions and orientations may be done among all the sensors at once, or in a sub-batch or “voting” process, whereby different subsets of the multitude of sensors are analyzed separately. This sub-batch analysis may reveal malfunctioning or otherwise erroneous sensors if, for example, including such a sensor in a sub-batch causes otherwise inexplicably higher errors in any loss or likelihood function. Knowledge of such malfunctioning or erroneous sensors may be used to discount, or even shut off, the inputs from those sensors, reducing their input into any other systems, and thereby reducing the errors propagated by such malfunctioning or erroneous sensors into any other systems.

Various embodiments may comprise a system and method for analyzing the output of multiple independent sensors and dynamically computing their intrinsic calibration coefficients.

As noted above, the analysis system and likelihood function may also comprise the estimation of intrinsic calibration parameters of the various sensors. These parameters may include such information as zero-reading bias, temperature dependencies, axis orthogonalities, or other measurements. These parameters may be transmitted back to the individual sensors for inclusion in any on-sensor computations, or may be stored and utilized at the system level. As before, these parameters may be computed in sub-batch form, used to identify malfunctioning or erroneous sensors, subject to various constraints, may be bootstrapped by prior knowledge, etc.

Various embodiments may comprise a system and method for controlling the manufacture of thin, transparent or semi-transparent layers on top of visual sensors.

In the manufacture of visual sensors, it may be advantageous to deposit, construct, wear away, or otherwise place, bond, and/or modify a transparent or semi-transparent layer of material in the optical path of the sensor itself. Such a problem is, for example, necessary in the construction of DOVS, as any amplitude or phase diffractive element is such a transparent or semi-transparent layer of material.

It is advantageous for the function of the full system for the properties of this layer to be controlled very precisely. Such properties may include thickness, positioning, microstructures, etc.

To ensure the precise control of such properties, rather than simply blindly executing a manufacturing process and attempting to measure and/or calibrate the end result, instead, the sensor may be powered-on, active, and transmitting output/debug/logging data during the manufacturing process itself. Such power supply and data output may be achieved through permanent traces or through temporary traces, which may be optimized for the manufacturing process, but removed or otherwise separated once complete.

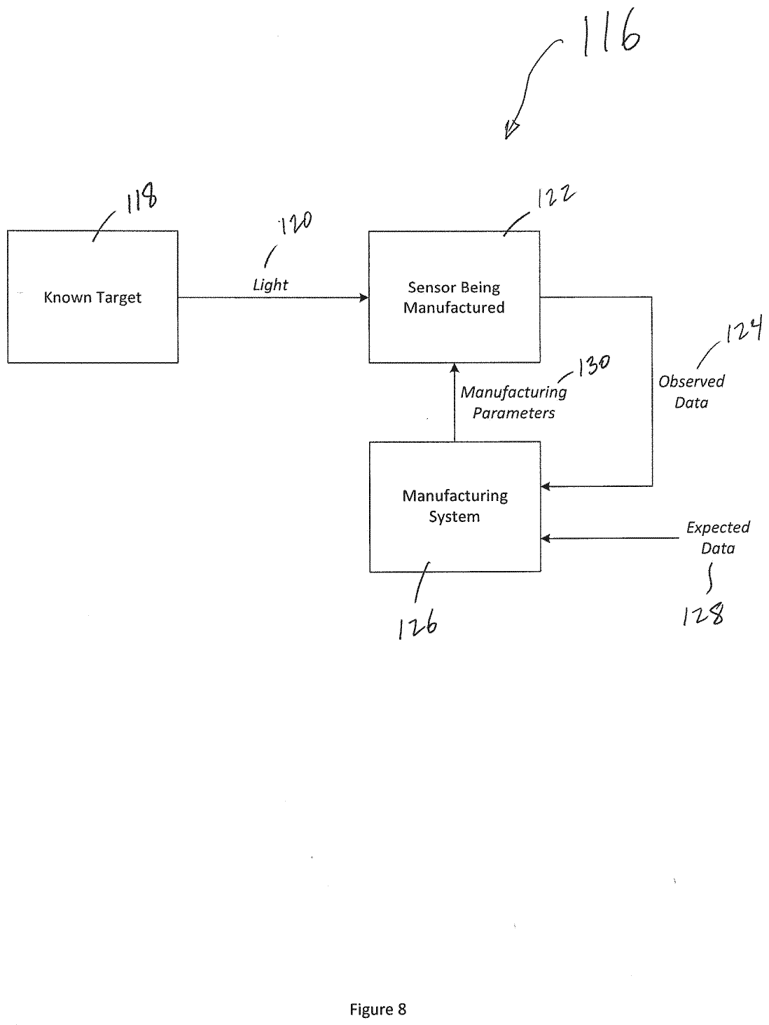

Such sensor output during the manufacturing process may be used as an input in a control algorithm for the manufacturing process itself. For example, if a known, desired property or performance has been determined, such as the sensor output when faced with a static target, then during manufacturing, the sensors-being-manufactured may be pointed at such a static target, and their output may be compared with the known, desired performance. Upon reaching some threshold relative to the known performance, this may signal the manufacturing system to modulate the manufacturing parameters. Referring to FIG. 8, a block diagram is illustrated for a manufacturing system (116) utilizing live data from a sensor being manufactured, in comparison to expected data, to modulate manufacturing parameters). A known target (118) may be used as an input, along with radiation or light (120) to a sensor being manufactured (122); observed data (124), expected data (128), aspects of the manufacturing system (126), and manufacturing parameters (130) may be utilized in a dynamic control loop, as shown in FIG. 8. For example, and without loss of generality, the manufacturing system may stop a material deposition process once a certain received light intensity has been detected by the sensor, while oriented towards a known and controlled light source. Such active feedback and control of the manufacturing process may include not just binary or continuous variables of manufacturing (e.g., material depths, curing times, etc), but may also include dynamic determination of architectural features, such as the application of additional isolation elements, compute capacity, etc. Such feedback information may be collected from a single target, or from a collection of targets, exposed in parallel or in sequence. Such targets may be static, such as a predetermined checkerboard pattern with controlled lighting, or may be dynamic, themselves adjusting to the output produced by the sensor so as to ensure precise control over the manufactured properties and operation of the sensor.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A system comprising an sensor device integrated to provide enhanced aspects pertaining to device calibration.
